(19) United States
(12) Patent Application Publication
(10) Pub. No.: US 2011/0113606 A1
(43) Pub. Date: May 19, 2011

(54) Shoelace Tying Device

(76) Inventor: Eileen Sloan, Evergreen, CO (US)

(21) Appl. No.: 12/883,274

(22) Filed: Sep. 16, 2010

Related U.S. Application Data
(60) Provisional application No. 61/260,750, filed on Nov. 12, 2009.

(51) Int. Cl. A43C 1/00; G09F 3/00

(52) U.S. Cl. 24/713.4; 40/299.01

(57) ABSTRACT

A device for tying a shoelace includes a planar-shaped body member including a first opening, a second opening, a third opening, and a fourth opening. Each of the openings is configured to allow the shoelace to be inserted there through. The first, second, third and fourth openings may be arranged in a two-by-two array, wherein the first and second openings form a first row of the array, and wherein the third and fourth openings form a second row of the array. The first and fourth openings may be coupled to one another by a first slit, and the second and third openings may be coupled to one another by a second slit.

### CROSS-REFERENCE TO RELATED APPLICATIONS

The present application claims priority to U.S. Provisional Patent Application Ser. No. 61/260,750, filed on Nov. 12, 2009, which is incorporated herein by reference.

### BACKGROUND OF THE INVENTION

1. Field of the Invention

The invention relates to a device for assisting one in tying a shoelace.

2. Description of the Prior Art

There are many “firsts” in one's life; some more exciting than others. One exciting “first” is when a child learns to tie their shoelace for the first time. Learning how to tie a shoelace is not an easy task. Typically, it takes instruction from an adult in addition to a lot of time and effort on the child's part.

In addition, people with disabilities, such as Parkinson's, arthritis, or other conditions that affect the ability to use one's hands effectively may have trouble tying a shoelace.

Various teaching aids and learning devices have been developed as an aid in teaching or helping to tie shoelaces in certain knots. One such a device is disclosed in U.S. Pat. No. 4,342,557 to Bandar. Bandar discloses a device that can be used to teach young children how to tie a double bow knot. However, not everyone uses the “bunny ear” method of tying shoes.

### SUMMARY OF THE INVENTION

A device for tying a shoelace includes a planar-shaped body member including a first opening, a second opening, a third opening, and a fourth opening. Each of the openings is configured to allow the shoelace to be inserted there through. The first, second, third and fourth openings may be arranged in a two-by-two array, wherein the first and second openings form a first row of the array, and wherein the third and fourth openings form a second row of the array. The first and fourth openings may be coupled to another by a first slit, and the second and third openings may be coupled to one another by a second slit.

### BRIEF DESCRIPTION OF THE DRAWING

The features of the invention will be better understood by reference to the accompanying drawing in connection with reading the specification in which:

FIG. 1 is a view in perspective of a shoelace tying device according to one embodiment of the invention;

FIGS. 2A-2K are perspective views showing the use of the device of FIG. 1 and the steps involved in tying one's shoelace.

### DETAILED DESCRIPTION OF THE INVENTION

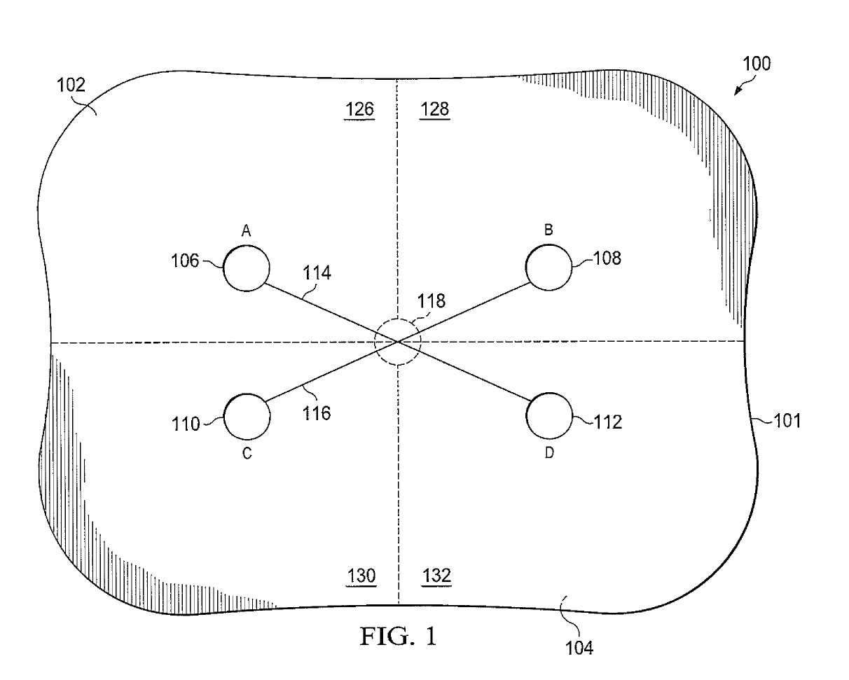

Turning now to the figures, there is disclosed in FIG. 1 a device 100 according to an embodiment of the invention that will be found quite useful in the tying of one's shoelace. In the illustrated embodiment, device 100 includes a body member 101 having a substantially planar upper face 102 and a substantially planar lower face 104. Body member 101 also includes a first opening 106, a second opening 108, a third opening 110, and a fourth opening 112. First opening 106 and fourth opening 112 are coupled to each other via a first slit 114, and second opening 108 and third opening 110 are coupled to each other via a second slit 116.

Body member 101 may be formed from any suitable material, with any suitable thickness, and may have any suitable size and shape. However, in one embodiment, body member 101 is formed from a suitable plastic material with the thickness of about 1/16″, and is generally rectangular-shaped with dimensions about 3 inches by 2½ inches. Although both upper face 102 and lower face 104 are illustrated in FIG. 1 as being substantially planar, in other embodiments, upper face 102 and lower face 104 may be slightly contoured to conform more closely to the upper part of a shoe where the laces generally reside.

Each of the first through fourth openings, 106, 108, 110, and 112, respectively, are illustrated in FIG. 1. as being in the form of a circular hole; however, other suitable shapes are contemplated by the present invention, such as oval, square, rectangular, etc. In addition, first through fourth openings, 106, 108, 110, and 112, respectively, may have any suitable dimensions. For example, in an embodiment in which the openings are circular holes, they may each have a diameter in a range of about 3/16″-¼″, which should be enough to accommodate various size shoelaces.

According to the teachings of the present invention, the configuration of first through fourth openings, 106, 108, 110, and 112, respectively, formed in body member 101 is a two-by two (2×2) array. This array may be a square array, a rectangular array, or may have other suitable array configurations. For example, the rows and columns of the array do not have to be aligned with one another. The configuration could be in the form of any suitable parallelogram, a trapezoid, or other suitable shape. Consequently, the openings may be spaced from one another any suitable distance. For example, in the illustrated embodiment, the openings are in a rectangular 2×2 array in which first and second openings 106, 108, and third and fourth openings 110, 112 are spaced in a range of about ⅞″-1¼″, and first and third openings 106, 110, and second and fourth openings 108, 112, are spaced in a range of about ¾″-1⅛″. It should be noted that the array may reside on any part of body member 101.

In one particular embodiment, body member 101 is “separated” into quadrants 126, 128, 130, 132, as illustrated in FIG. 1 by the use of dashed lines. The quadrants may or may not be of equal surface area. In this embodiment, each quadrant will be associated with one opening. For example, first opening 106 will be associated with first quadrant 126, second opening 108 will be associated with second quadrant 128, third opening 110 will be associated with third quadrant 130, and fourth opening 112 will be associated with fourth quadrant 132.

First and second slits 114, 116, may each have any suitable width and have any suitable configuration; however, in one embodiment, as illustrated in FIG. 1, slits 114, 116 are substantially straight lines having a minimal (e.g., 1/32″) width. First slit 114 extends between first opening 106 and fourth opening 112, and second slit 116 extends between second opening 108 and third opening 110. In one embodiment, there exists an opening 118 at the intersection of 101, to allow body member 101 to be “released” from a shoelace, as described in more detail below.

Also illustrated in FIG. 1 are indicia for the openings to be used with suitable instructions on how to tie a shoelace using device 100. For example, the letter “A” is associated with opening 106, the letter “B” is associated with opening 108, the letter “C” is associated with opening 110, and letter “D” is associated with opening 112.

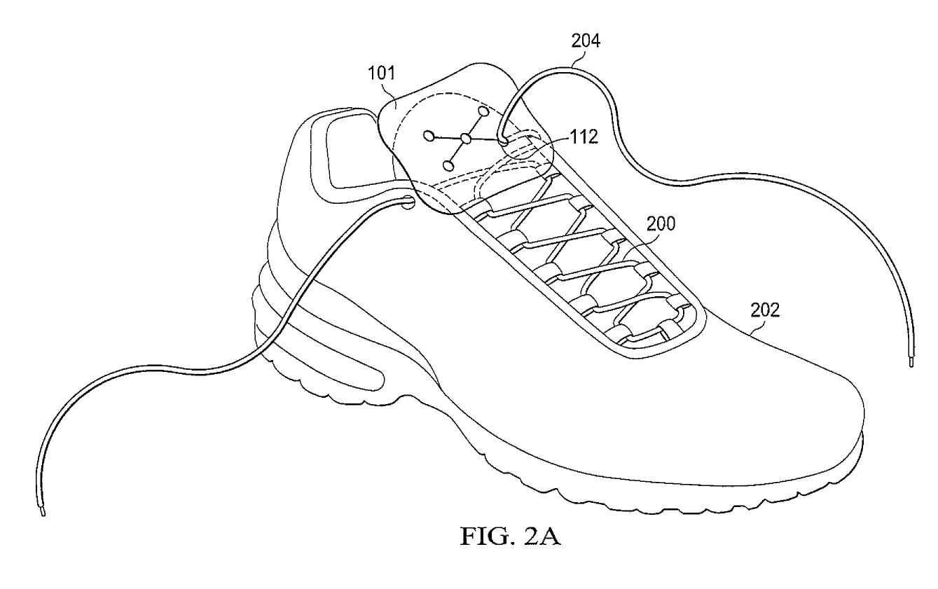

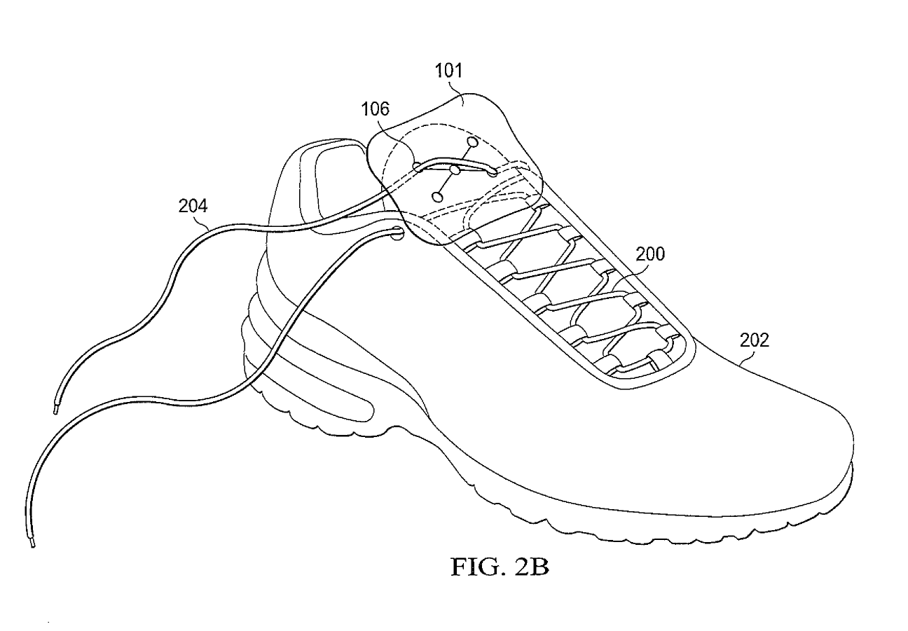

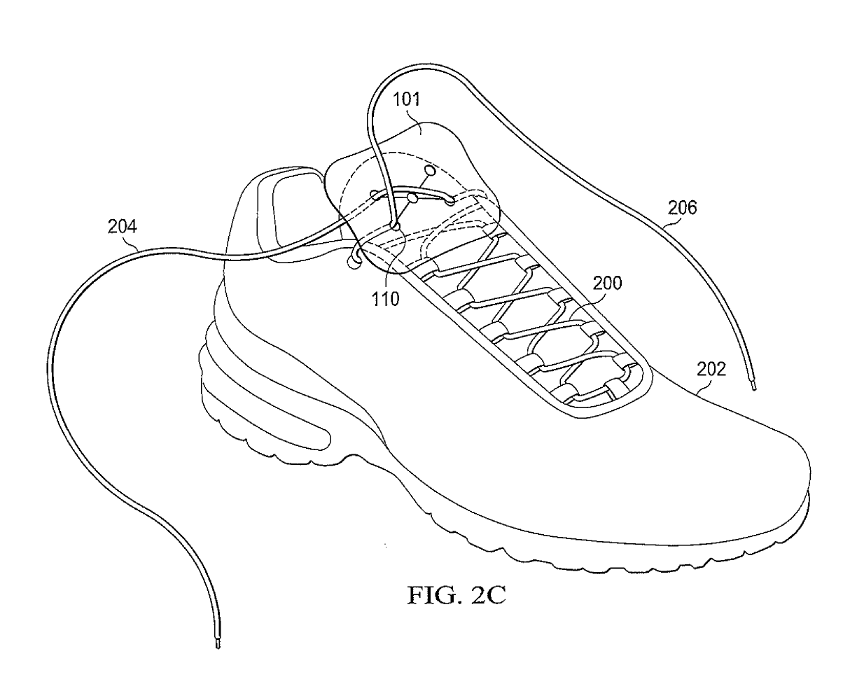

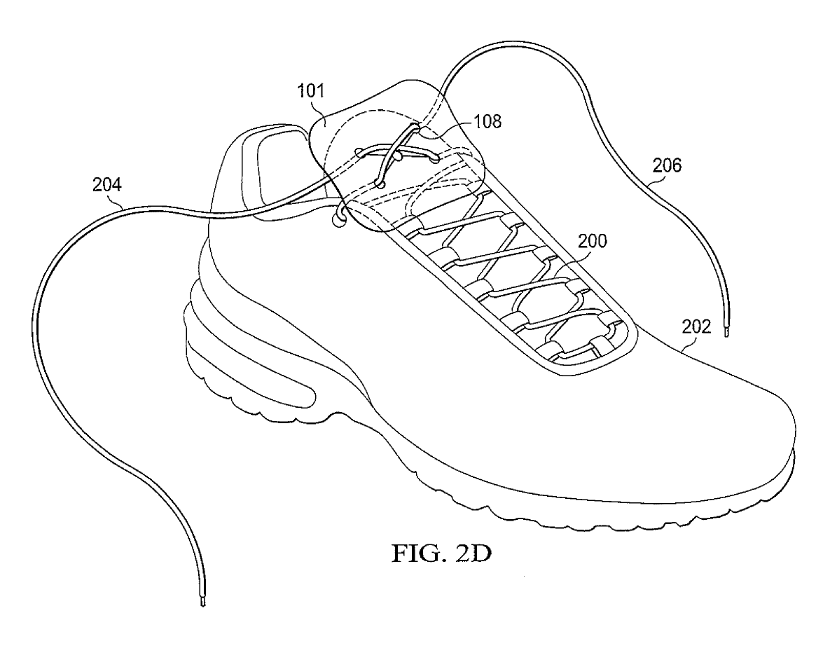

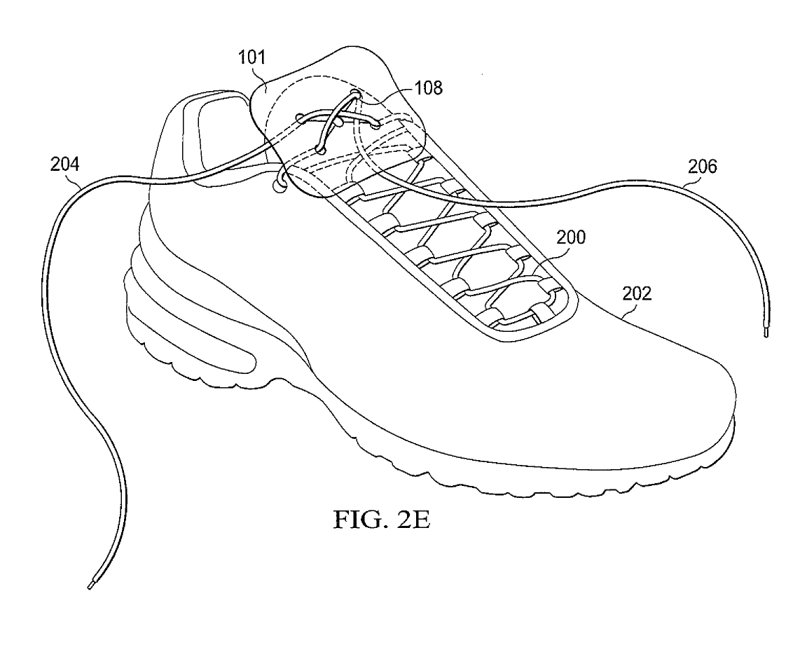

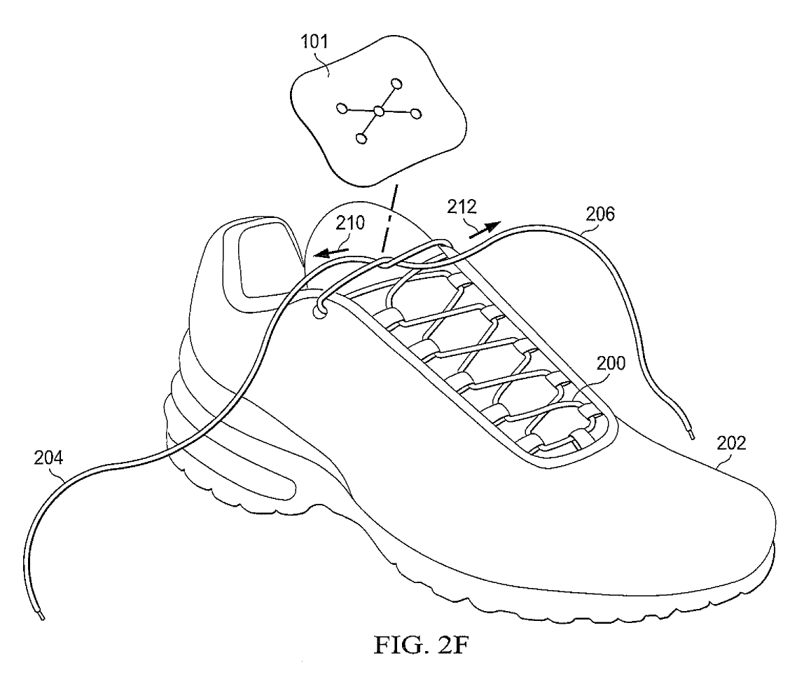

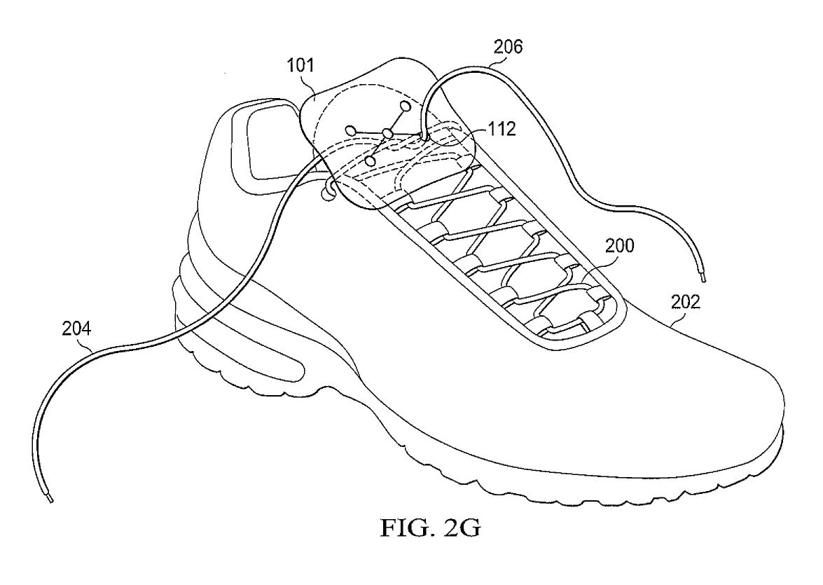

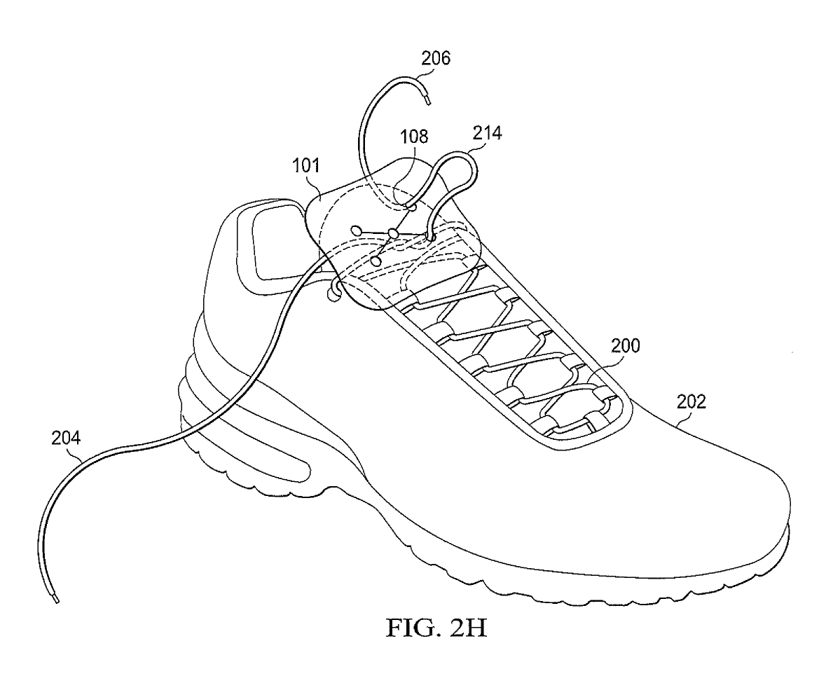

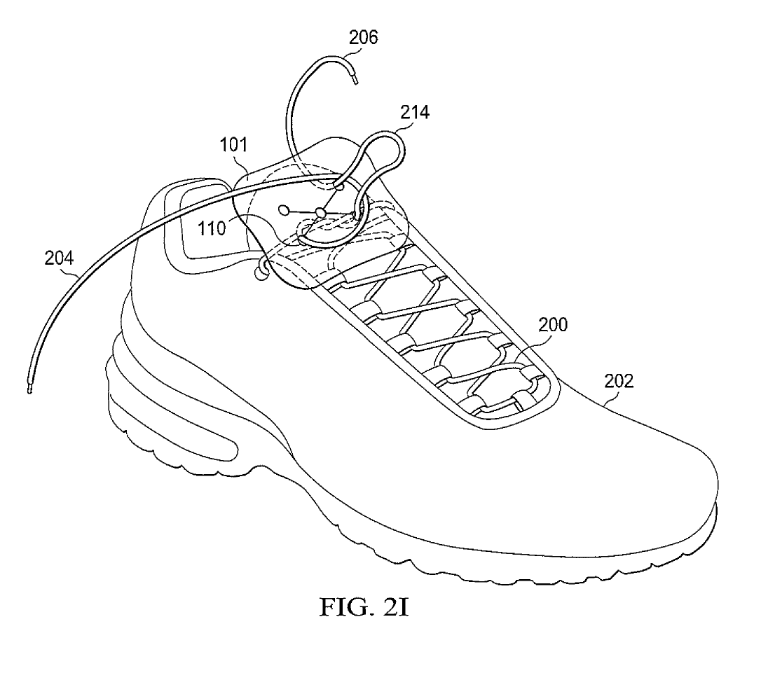

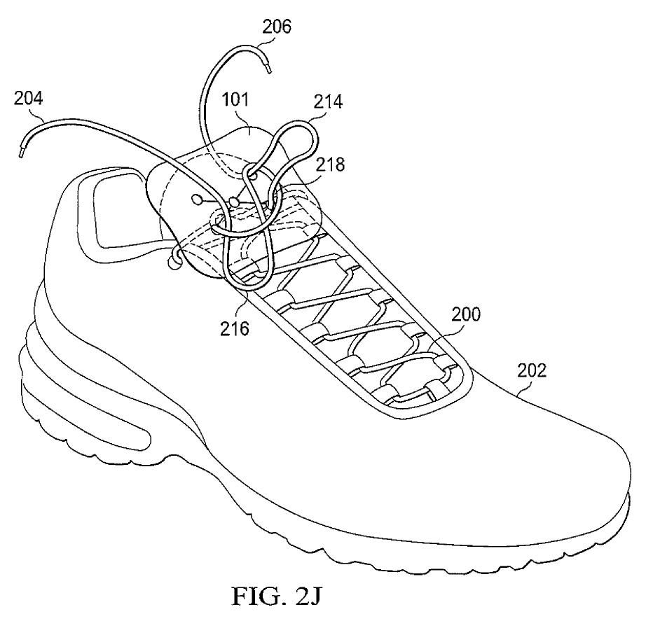

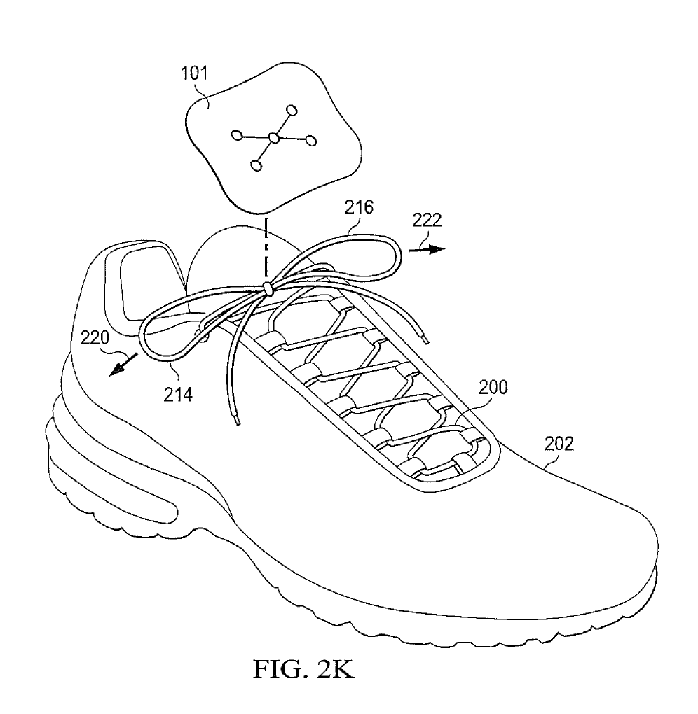

Referring now to FIGS. 2A-2K, a method of using device 100 to tie a shoelace 200 according to one embodiment of the invention is illustrated. In FIG. 2A, body member 101 is placed over the upper part of a shoe 202. The first step is to take a first end 204 of shoelace 200 and insert it through opening 112 starting at lower face 104. The next step, as illustrated in FIG. 2B, is to take first end 204 and insert it through opening 106 starting at upper face 102.

Referring to FIG. 2C, the next step of the method is illustrated. A second end 206 of shoelace 200 is inserted through opening 110 starting at lower face 104, And then second end 206 is inserted through opening 108 starting at upper face 102, as illustrated in FIG. 2D.

As illustrated in FIG. 2E, the second end 206 of shoelace 200 is then positioned underneath shoelace 200 adjacent first end 204. Referring to FIG. 2F, a force as illustrated by arrow 210 is then applied to first end 204 of shoelace 200, and a force 212 as illustrated by arrow 212 is applied to second end 206 of shoelace 200. When the forces are applied, body member 101 will be released from shoelace 200. This release is possible because of the slits 114 and 116 (and opening 118 if utilized).

Referring now to FIG. 2G, body member 101 is re-positioned on the upper part of shoe 202 proximate the ends 204, 206 of shoelace 202. Second end 206 of shoelace 200 is inserted through opening 112 starting at lower face 104, and then inserted back through opening 108 starting at upper face 102 (FIG. 21-1) This will form a loop 214. First end 204 of shoelace 202 is then inserted through opening 110, as illustrated in FIG. 21, starting at lower face 104 and “looped” around the loop 214 in the counterclockwise direction (although a clockwise direction is also contemplated).

Referring now to FIG. 2J, a loop 216 is formed a short distance away from first end 204 of shoelace 202. This is probably done easiest by a user's thumb. Loop 216 is then inserted back through an opening 218 formed between loop 214 and the portion of first end 204 that was wrapped around loop 214. To finish the tying of shoelace 202, as illustrated in FIG. 2K, a force as illustrated by arrow 220 is applied to loop 214 and a force as illustrated by arrow 222 is applied to loop 216. When the forces are applied, body member 101 may be released from shoelace 200 via slits 114 and 116 automatically, or the user may have to hold the center of the tied knot and apply a gentle pull force to body member 101 to release the body member from shoelace 200.

One skilled in the art will understand that the method steps described in FIGS. 2A-2K may be done in an opposite manner. For example, if the method described in FIGS. 2A-2K may be referred to as a “right-handed” shoe tying method, then a “left-handed” shoe tying method is also applicable by “reversing” the steps.

While several embodiments of the disclosure have been shown in the FIGURES, it is not intended that the disclosure be limited thereto, as it is intended that the disclosure be as broad in scope as the art will allow and that the specification be read likewise. Therefore, the above description should not be constructed as limiting, but merely as examples of particular embodiments. Those skilled in the art will envision other modifications within the scope and spirit of the claims appended hereto.

What is claimed is:

1. A device for tying a shoelace, comprising:
a planar-shaped body member including a first opening, a second opening, a third opening, and a fourth opening, each of the openings configured to allow the shoelace to be inserted therethrough;
the first, second, third and fourth openings arranged in a two-by-two array, wherein the first and second openings form a first row of the array, and wherein the third and fourth openings form a second row of the array; and
wherein the first and fourth openings are coupled to one another by the first slit, and the second and third openings are coupled to one another by a second slit.

2. The device of claim 1, wherein the planar-shaped body member is of rectangular configuration.

3. The device of claim 1, wherein the openings are circular-shaped.

4. The device of claim 1, wherein the two-by-two array is a square array.

5. The device of claim 1, wherein the two-by-two array is a rectangular array.

6. The device of claim 1, wherein the two-by-two array is in the form of a parallelogram.

7. The device of claim 1, wherein the two-by-two array is in the form of a trapezoid.

8. The device of claim 1, wherein the first and second openings and the third and fourth openings are spaced in a range of about ⅞″-1¼″, and wherein the first and third openings and second and fourth openings are spaced in a range of about ¾″-1⅛″.

9. The device of claim 1, further comprising a first opening located at the intersection of the first and second slits.

10. The device of claim 1, wherein the openings each include unique indicia.

11. A device for tying a shoelace, comprising:
a planar-shaped body member, the body member including a first quadrant, a second quadrant, a third quadrant, and a fourth quadrant;
a first opening associated with the first quadrant, a second opening associated with the second quadrant, a third opening associated with the third quadrant, and a fourth opening associated with the fourth quadrant, each of the openings configured to allow the shoelace to be inserted therethrough; and
wherein the first and fourth openings are coupled to one another by a first slit, and the second and third openings are coupled to one another by a second slit.

12. The device of claim 11, wherein the planar-shaped body member is of rectangular configuration.

13. The device of claim 11, wherein the openings are circular-shaped.

14. The device of claim 11, wherein the first and second openings and the third and fourth openings are spaced in a range of about ⅞″-1¼″, and wherein the first and third openings and second and fourth openings are spaced in a range of about ¾″-1⅛″.

15. The device claim 11, further comprising a fifth opening located at the intersection of the first and second slits.

16. The device of claim 11, wherein the openings each include unique indicia.
